(19) United States
(12) Patent Application Publication
(10) Pub. No.: US 2009/0172076 A1
(43) Pub. Date: Jul. 2, 2009

(54) Community information and news flow network

(75) Inventor: William R. Dunbar, Oconomowoc, WI (US)

Correspondence Address: REINHART BOERNER VAN DEUREN P.C., 2215 PERRYGREEN WAY, ROCKFORD, IL, 61107, US

(73) Assignee: United Communications Corporation, Kenosha, WI (US)

(21) Appl. No.: 11/967,693

(22) Filed: Dec. 31, 2007

(51) Int. Cl. G06F 15/16

(52) U.S. Cl. 709/202

(57) ABSTRACT

A system is described that provides a localized community information and news flow network. Devices are employed throughout a community to input news and information and automatically (or in an automated fashion) send the information to one or more predetermined locations. Once the data has been stored, the information is aggregated and processed, including an “auto-report” feature to transform the information/data, in part or in whole into view-ready news stories. An integrated network is established, including satellite and Internet receivers throughout the community, in order to automatically transmit to the community for viewing the transformed news stories in various forms such as video news clips, photos, tabular graphics, etc.

### BACKGROUND

Information networks have evolved to the point where information can flow electronically, either hard-wired or wirelessly. Currently, news and information flows to a media company via paper transfers, voicemails and telephone conversations, electronically through email systems, electronically through established user interfaces with the community, and/or via field reporters. In most cases, the news and information (data, etc.) input is accomplished manually in the sense that an action must be taken beyond the normal operation of the news event in order to input news to the local media company.

When raw data is received by the local media company, newsroom personnel use the raw data to write news articles to be sent back to various community platforms such as newspapers, radio, television, internet websites, etc.

### BRIEF SUMMARY

A system is devised providing an electronic integration that enables a localized community information and news flow network. Devices are employed throughout a community to input news and information and are designed to be used as an integral part of the event/activity as well as automatically (or in an automated fashion) sending the information to a one or more predetermined locations. Once the data is stored, the information is aggregated and processed, including use of an “auto-report” feature to transform the information/data, in part or in whole into print-ready verbiage such as news stories. An integrated network is established, including remote receivers throughout the community, to automatically (or in an automated fashion) transmit to the community for displaying and viewing the transformed news stories in various forms such as video news clips, photos, tabular graphics, etc.

In one embodiment, the system provides hardware and/or software devices that are designed for various specific community activity applications such as baseball “e-clickers”, soccer “e-scorers”, etc. These devices are provided to the appropriate user (e.g., umpire, referee, official scorer, etc.) to use to track the event (e.g., keep score). The devices serve to provide automated data storage and transmittal to the predetermined location(s) (e.g., a centralized server) in order to then transform the data into a viewing format.

In another embodiment, the system provides an interface between existing electronic devices and the predetermined location(s) to provide an automated data feed to a media aggregator.

In a further embodiment, once the data is received and stored, an auto-report feature transforms raw data into news articles/stories in “print- and “viewer-ready” conditions such as, for example, news articles for print as well as storyline highlights for other uses such as radio or television reporting.

In a further embodiment, the system provides an electronic network to flow information back to the community via “remote receivers” from the predetermined location(s). These remote receivers may be hard-wired or wireless (likely wireless). They serve to receive and then locally transmit the transformed news stories in various forms, such as storyline highlights, digital photos, video clips, etc.

Other aspects, objects and advantages will become apparent from the following brief description of the drawings.

### DESCRIPTION OF THE DRAWINGS

FIG. 1 is a block diagram of an exemplary embodiment of a system in accordance with the teachings herein;

FIG. 2 is a block diagram of an embodiment illustrating interconnections between scoring systems located at games/events and a system in accordance with the teachings herein;

FIG. 3 is a flow chart of the steps that the system performs to receive and manipulate raw data for a community sports event or other activity;

FIG. 4 is an illustration of a webpage that contains an area for print-ready text generated by the auto-report module of FIG. 1;

FIG. 5 is a flow chart of the steps that a user and the auto-report module of FIG. 1 performs to automatically generate print-ready verbiage in accordance with the teachings herein;

FIG. 6 is an illustration of print-ready verbiage generated by the auto-report module of FIG. 1;

FIG. 7 is a flow chart of the steps that the on-site scoring/statistics module of FIG. 1 performs;

FIG. 8 is a block diagram illustrating the interconnectivity of the system described herein;

FIG. 9 is a flow chart of the steps taken to provide the interconnectivity illustrated in FIG. 8; and

FIG. 10 is a block diagram illustrating a hardware scoring device in accordance with the teachings herein.

While the system will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

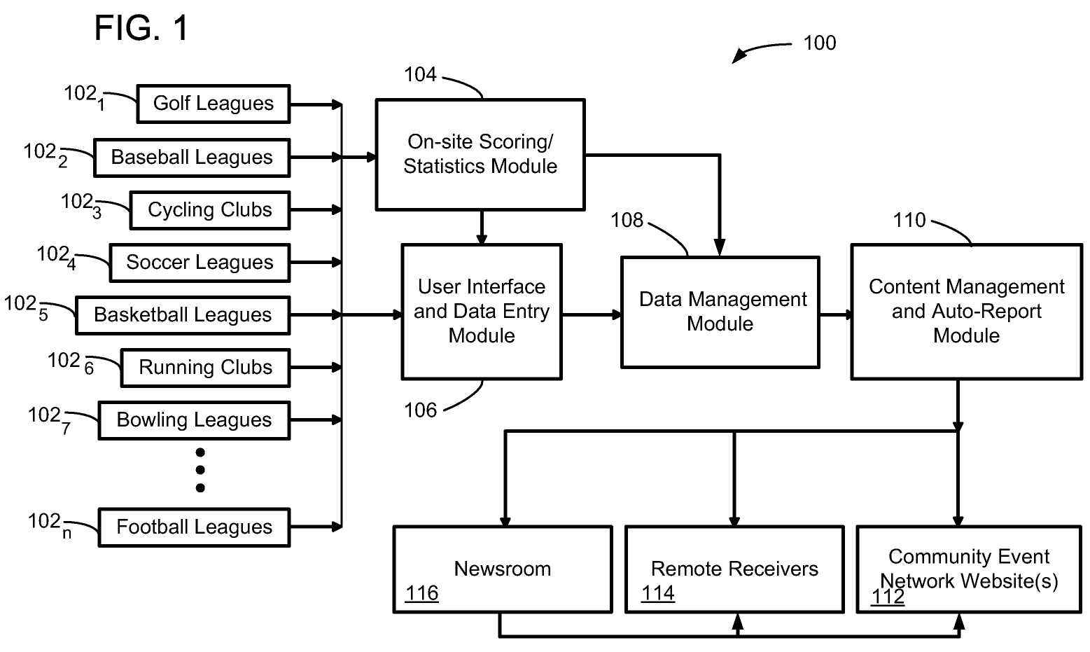

Referring to FIG. 1, an exemplary embodiment 100 of the system in a sporting event environment is shown. The system may be used in other environments. For example, it can be used to report community social events, community news events, etc.

The on-site scoring/statistics module 104 receives data from sport leagues 102₁, to 102ₙ from appropriate personnel (e.g., umpire, referee, official scorer, etc.). The module 104 can interface with or be an integral part of hardware devices such as baseball “e-clickers,” soccer “e-scorers,” scoreboards, etc. to automatically obtain the data. The data can include player stats (e.g., points, hits, fouls, etc.), time (e.g., period, time remaining, frames bowled, inning, etc.), team information (e.g., score, overall time, fouls, hits, etc.) and the like. The module 104 interfaces with a user interface and data entry module 106 that sends the data to data management module 108. Alternatively, module 104 directly sends data to data management module 108.

The appropriate personnel use user interface and data entry module 106 to manually enter data. League participants enter data, such as individual statistics for hitting, pitching, etc., as well as game summaries, including, in some cases, photo and video submission. For example, a golfer in a golf league 102₁ enters his or her score, a score keeper may enter scores and statistics on players, a bowler may enter scores of bowlers in a bowling league, etc.

Data entered is stored in data management module 108, from which calculations are performed resulting in another level of statistics, such as batting averages, earned run averages, team/individual standings, etc. Data management module 108 may include multiple data storage servers located at one or more selected locations. For example, the servers could be stored in a central location or distributed throughout the communities being served.

The content management and auto-report module 110 transforms the data into a format for viewing at community event network website(s) 112 and/or at remote receivers 114 throughout the community and/or region. The auto-report function automatically transforms parts of the data entered into print-ready verbiage for display on/in the various platforms. Print-ready verbiage means the data is in a grammatically correct format that is readable by an end user or ready for additional editing or review at newsroom 116. Newsroom 116 may be a newspaper newsroom, a television news station, etc.

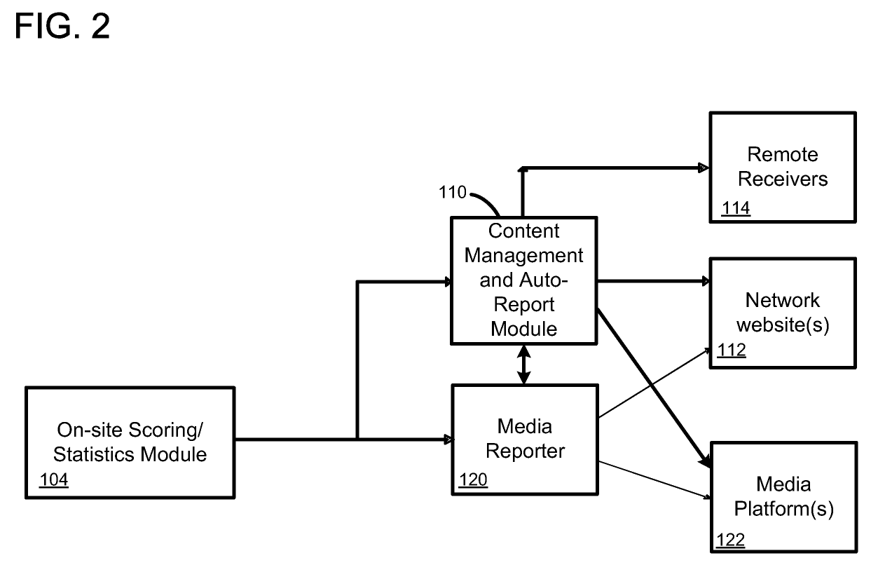

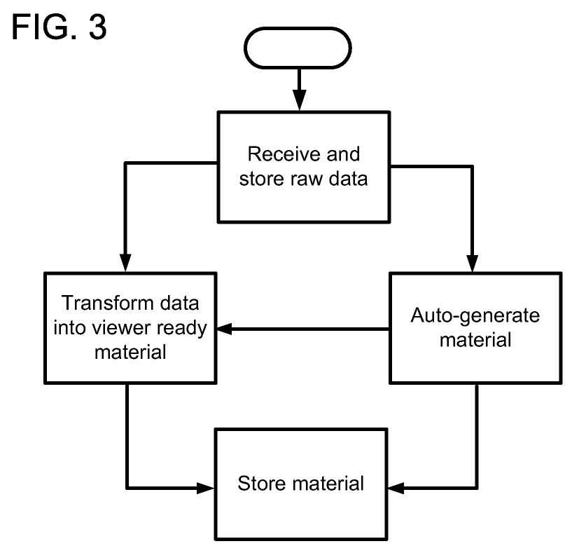

Turning now to FIGS. 2 and 3, the content management and auto-report module 110 receives the statistics sent from on-site scoring/statistics module 104 and user interface and data entry module 106 (not shown) via data management module 108 (not shown). Using templates, the auto-report feature populates the templates to produce “news-ready” material such as articles, stories, highlights, lead sentences, etc. As an example, assume that a home baseball team won a game in eleven innings with the final score of 9 to 7 and statistics have been entered for outfielder John Smith that include 5 hits at 8 at bats, 2 singles, a double, a triple, and one home-run. The auto-report feature would then retrieve the information and use a selected template to change the statistics to text that, for example, reads “Kenosha beat Racine last night after 11 innings with a final score of 9 to 7. Outfielder John Smith hit for the cycle with two singles, a double, a triple, and a home-run to lead Kenosha to victory.”

The templates consist of verbiage that a media reporter 120 would typically use in an article. Many media reporters use certain phrases over and over, but in different areas of an article and in different ways from article to article. Each template has these phrases and other commonly used phrases populated in the template. For example, there may be several templates for sports articles, with each template modeled after variations the media reporter uses. The template(s) used may be user-selected or randomly picked. For some articles, the auto-report feature transforms the data into phrases, sentences, or a complete story by piecing together the statistics into one or more templates. The content management module 110 then adds charts, graphs, etc. when appropriate to the transformed data. These articles are transmitted to one or more network websites 112 in the community network. In one embodiment, the articles are transmitted to receivers 114 for display, one or more network websites 112, and/or to the appropriate location for adding to a daily or weekly newspaper or other media platforms (e.g., cell phones, television, radio, etc.) 122.

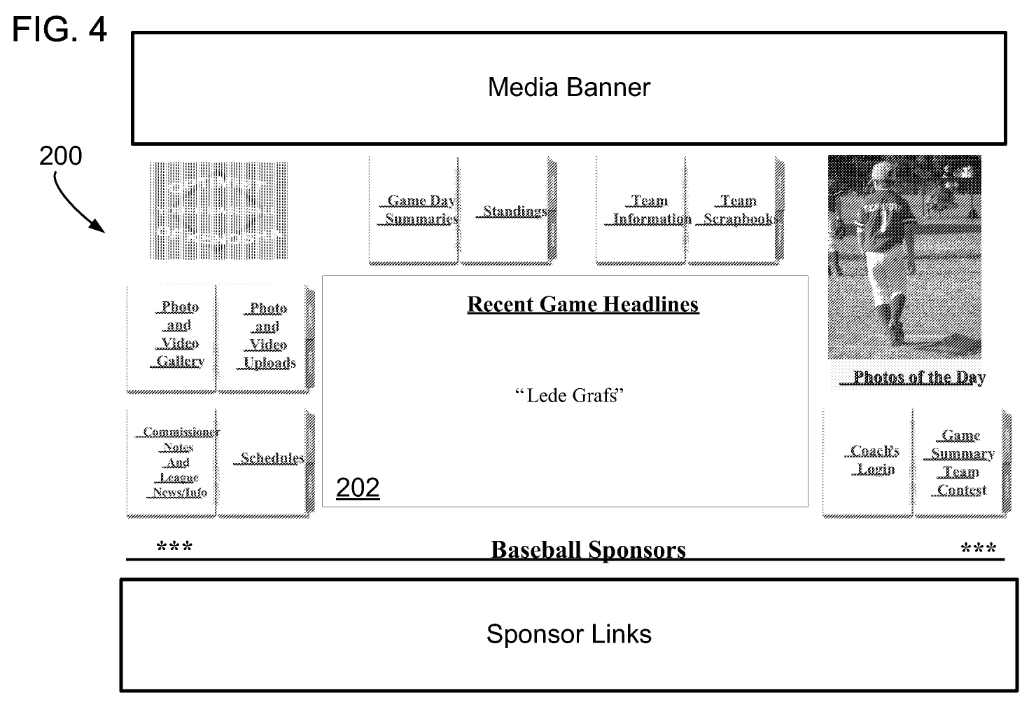

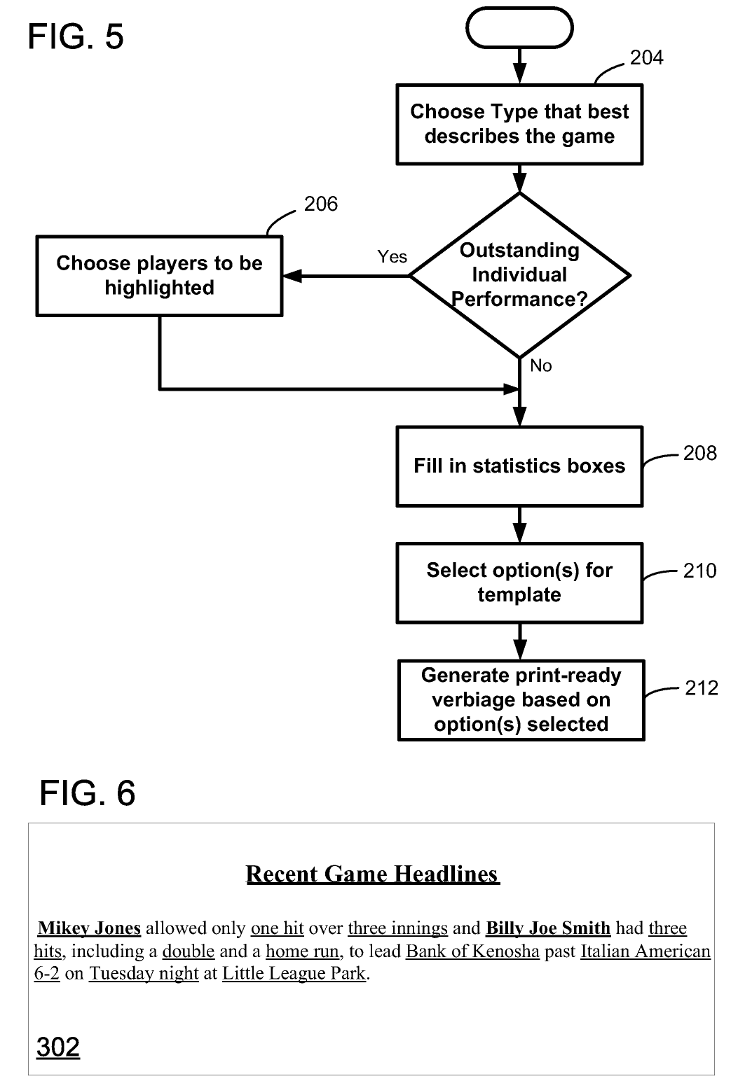

An example of the auto-report feature is illustrated in FIGS. 4-6. The auto-report feature uses input data to generate the report. An example of a web page 200 is shown in which the auto-generated data is placed in Recent Game Headlines block 202. In the example shown, a baseball game shall be used to describe the auto-report feature. A designated statistician (e.g., a coach) enters information about the game, including data such as the score, player stats (hits, RBI, etc.), etc. The statistician chooses the type that best describes the game (step 204). For example, the type of game can be a “combined team effort,” “outstanding individual performance(s),” a “dramatic ‘walk-off’ finish,” or a “fortunate victory.” If the type of game selected is “outstanding individual performance(s),” the statistician selects from a list the player name(s) and whether the performance was batting, pitching, and/or defense (step 206). The statistician also enters stats for each player and the team (step 208). The auto-report feature uses the data entered to generate a “lede graf,” phrases, sentences, complete article, etc. for the game. The auto-report feature parses the information to create a universe of possible options and randomly selects an option for the first paragraph or “lede graf.” Alternatively, the user selects the options (step 210).

The options are based upon the statistics entered. Table 1 lists an example of options for a team sports game (e.g., baseball, basketball, football, volleyball, etc.) for reporting the final score. The auto-report feature automatically adds the appropriate statistics and information (e.g., teams, scores, players, etc.) to the option selected to generate a part of the print-ready verbiage and combines the parts of the print-ready verbiage to form the print-ready verbiage.

TABLE 1

| Text Option | When Used |
|---|---|
| to lead <team1> past <team2> <score> | any time |
| as <team1> knocked off <team2> <score> | any time |
| to give <team1> a <score> win over <team2> | any time |
| as <team1> beat <team2> <score> | any time |
| as <team1> nailed down a <score> win over | any time |
| <team2> | |
| as <team1> came from behind to beat <team2> | when a team comes |
| <score> | from behind to win |
| as <team1> pounded <team2> <score> | when there is a |
| | one-sided score |
| as <team1> blanked <team2> <score> | when there is a |
| | one-sided score |
| as <team1> whitewashed <team2> <score> | when there is a |
| | one-sided score |
| as <team1> managed to edge <team2> <score> | when there is a close |
| | game |

Turning to FIG. 6, an example of an auto-generated lede graf is illustrated. The auto-report feature generated the text based upon the type of game selected (e.g., outstanding individual performance), the names of the players selected and each selected player's performance, the score, the date and time, and the location. In FIG. 6, the underlined text indicates the data used by the auto-report feature to generate the lede graf.

Note that a media reporter 120 may update the template and/or manually edit the article created by the template. For some articles, the media reporter adds further information to the template and then sends the resulting article to one or more network websites 112 in the community network and/or to the appropriate location for adding the article to other media platforms such as a daily or weekly newspaper. In one embodiment, the articles are also transmitted to receivers 114.

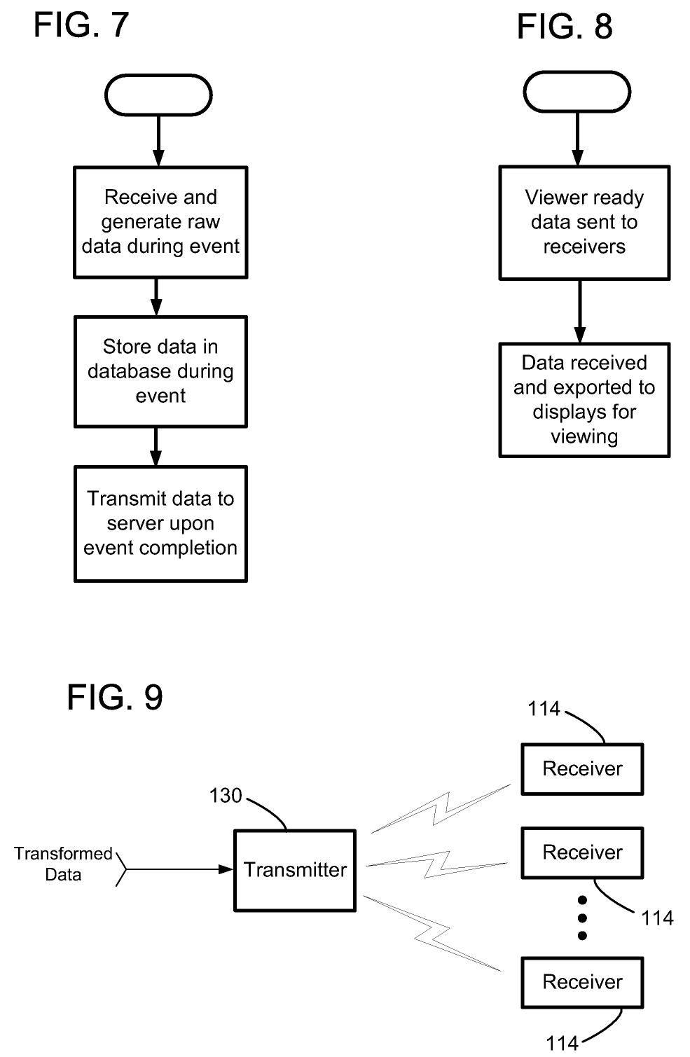

Turning now to FIG. 7, the on-site scoring/statistics module 104 ordinarily receives and generates raw data during an event, stores the data in a database, and then transmits the data to an appropriate content management and auto-report module 110 via data management module 108, which are located on one or more servers.

Turning now to FIGS. 8 and 9, the steps taken to transmit articles and other items to receivers for display shall now be described. Transformed data such as the articles are sent to transmitter 130. Transmitter 130 can be a satellite transmitter, a wireless transmitter, etc. The transmitter 130 transmits the articles and other items to one or more receivers 114. When an article or other item is received, each receiver displays the transmitted article or other item. In one embodiment, the articles and other items may be encrypted such that only one or more select receivers are able to display the transmitted article or other item. For example, each receiver may be assigned a globally unique identification (GUID). Articles or other items transmitted have the GUIDs for the desired receivers to display the article or other items within the transmission so that only the receivers with the identified GUIDs display the article or other items.

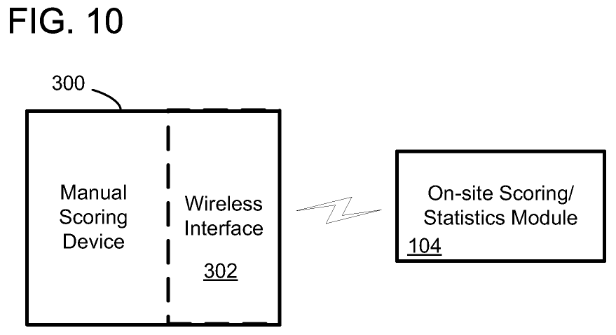

The system provides wireless scoring devices that interface with the on-site scoring/statistics module 104. The wireless scoring devices can use software downloaded into existing data entry devices, integrated as part of a hardware device, etc. Turning now to FIG. 10, many sports use a manual scoring device 300. To enable the use of manual scoring devices, the manual scoring devices are equipped with a wireless interface 302 that transmits what is entered to the on-site scoring/statistics module 104. For example, baseball and softball umpire devices (e.g., 3 count [balls, strikes, outs] or 4 count [balls, strikes, outs, innings] clickers) can be fit with the wireless interface and as an umpire changes the count, the wireless interface transmits the change to the on-site scoring/statistics module 104. Additionally, electronic scoreboards can be fitted with a wireless interface to automatically update the count on the scoreboard. Alternatively, for ballparks that do not have electronic scoreboards, the change can be transmitted to the scorekeeper via a wireless receiver such as a cell phone (not shown). Other examples include transmitting information from a basketball, volleyball, or hockey scoreboard, an umpire's watch for the time of a soccer goal and the official time, a bowling scoreboard, a runner's or a cycler's finish time, and the like. The wireless interface can also be used for other events. For example, in a fishing tournament, a device with a wireless interface can be provided to each participant in the competition to provide counts of fish caught. The wireless interface sends the fish count to the on-site scoring/statistics module 104. Alternatively, the wireless interface consists of a software module that is provided for download to participants who have an existing wireless interface (e.g., a cell phone) and the software module directs the existing wireless interface to send the fish count to the on-site scoring/statistics module 104. The system 100 uses the count to provide a real-time account of the fish caught and/or a summary of the final numbers of fish caught.

From the foregoing, it can be seen that a localized community information and news flow network has been provided. Devices are employed throughout a region to input news and information as well as automatically (or in an automated fashion) sending the information to one or more predetermined locations. Once the data has been stored, the information is aggregated and processed, including an “auto-report” feature to transform the information/data, in part or in whole into print-ready verbiage such as view-ready news articles. The integrated network includes satellite and/or Internet receivers throughout the community, in order to automatically transmit to sites within the community for display the transformed news stories in various forms such as video news clips, photos, tabular graphics, etc.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A community information and news flow network comprising:
at least one module configured to receive data about a community event;
a data management module in communication with the at least one module, the data management module storing data received by the at least one module; and
a content management module having an auto-report module, the content management module transforming data into a format for viewing at one or more locations in the community, the auto-report module automatically transforming a portion of the data into print-ready verbiage, the content management module transmitting the transformed data and print-ready verbiage for display at the one or more locations.

2. The community information and news flow network of claim 1 wherein the at least one module comprises a user interface and data entry module for enabling a user to manually enter data about the community event.

3. The community information and news flow network of claim 1 wherein the content management module wirelessly sends transformed data to the one or more locations.

4. The community information and news flow network of claim 1 wherein the auto-report module automatically transforms the portion of the data into print ready verbiage by performing the steps comprising:
retrieving data about the community event;
parsing the data to obtain information regarding the community event;
selecting at least one text option to use to display the information;
adding the information to the at least one text option to create a part of the print-ready verbiage; and
combining the part of the print-ready verbiage to other parts of the print-ready verbiage to form the print-ready verbiage.

5. The community information and news flow network of claim 1 further comprising a media reporter interface to allow a user to edit the print-ready verbiage.

6. The community information and news flow network of claim 1 wherein the at least one module comprises at least one on site scoring and statistics module.

7. The community information and news flow network of claim 6 wherein the at least one on-site scoring and statistics module includes a device that a user employs to track the community event.

8. The community information and news flow network of claim 7 wherein a wireless interface is added to the device.

9. The community information and news flow network of claim 1 wherein the content management module transforms data into one of a video news clips or at least one photo.

10. The community information and news flow network of claim 1 wherein the one or more locations in the community includes a network site and at least one remote receiver.

11. The community information and news flow network of claim 1 wherein the community event includes a baseball game of a baseball league, a soccer game, a basketball game, and a football game.

12. A computer-implemented method to generate information about an event in a community information and news flow network comprising the steps of:
receiving data about a community event;
transforming the data into a format for viewing at one or more locations in the community; and
transforming a portion of the data into print-ready verbiage.

13. The computer-implemented method of claim 12 further comprising the step of wirelessly sending the transformed data to a remote receiver.

14. The computer-implemented method of claim 12 further comprising the step of enabling a user to manually enter data about the community event.

15. The computer-implemented method of claim 12 wherein the step of transforming a portion of the data comprises the step of:
parsing the data to obtain information regarding the community event;
selecting at least one text option to use to display the information;
adding the information to the at least one text option to create a part of the print-ready verbiage; and
combining the part of the print-ready verbiage to other parts of the print-ready verbiage to form the print-ready verbiage.

16. The computer-implemented method of claim 12 further comprising the step of providing at least one device to a selected user to use to track the community event.

17. The computer-implemented method of claim 12 further comprising the step of sending the transformed data to at least one of a network site and a remote receiver.

18. The computer-implemented method of claim 17 wherein the step of sending the data comprises the step of wirelessly sending the transformed data to the at least one of the network site and the remote receiver.

19. A device for use with the community information and news flow network of claim 1 comprising:
a score keeping mechanism; and
a wireless interface in communication with the score keeping mechanism, the wireless interface transmitting data to the on-site scoring/statistics module.

20. The device of claim 19 wherein the wireless interface comprises a software module that directs an existing interface to transmit data to the on-site scoring/statistics module.
